(19) United States
(12) Patent Application Publication
(10) Pub. No.: US 2020/0218976 A1
(43) Pub. Date: Jul. 9, 2020

(54) METHOD FOR GENERATING AT LEAST ONE RECOMMENDATION

(71) Applicants: SIEMENS AKTIENGESELLSCHAFT, München (DE); SIEMENS S.P. A., Milano (IT)

(72) Inventors: Thomas Hubauer, Garching bei München (DE); Giovanni Bechini, Uzzano (IT); Christer Karlsson, Linköping (SE)

(21) Appl. No.: 16/647,480

(22) PCT Filed: Sep. 11, 2018
(86) PCT No.: PCT/EP2018/074429

§ 371 Date: Mar. 13, 2020

(30) Foreign Application Priority Data
Sep. 14, 2017 (EP) 17191119.1

(51) Int. Cl. G06N 3/08; G06N 3/04

(52) U.S. Cl. CPC G06N 3/08; G06N 3/0454; G06N 3/0445

(57) ABSTRACT

A method for generating at least one recommendation includes receiving a case embedding, generating the at least one recommendation based on the case embedding using deep learning, and outputting the at least one recommendation.

This application is the National Stage of International Application No. PCT/EP2018/074429, filed Sep. 11, 2018, which claims the benefit of European Patent Application No. 17191119.1, filed Sep. 14, 2017. The entire contents of these documents are hereby incorporated herein by reference.

### TECHNICAL FIELD

The present embodiments relate to generating at least one recommendation.

### BACKGROUND

Remote monitoring and diagnostics of rotating equipment is indispensable in practice. Remote diagnostics of gas turbines is a complex task that may be divided into three steps: (1) Detection; (2) Isolation; and (3) Diagnosis. Recently, there has been an increased demand for a systematic approach to plant process safety, increased reliability and availability, lower maintenance cost, and continuous awareness about the equipment health status. This demand challenges the existing tool landscape that typically builds on an adoption of condition monitoring solutions and expert systems. Specifically, fault detection, fault isolation, failure mechanism definition, and diagnosis definition as part of the systematic diagnostics are fundamental functionality to support engineers in the decision making process, until the corrective action recommendation.

However, due to the technical complexity caused by the large number of subsystems and process flows, diagnosis for industrial gas turbines is non-trivial and requires multi-disciplinary expertise of various engineers from domains such as system mechanics, aerodynamics, and thermodynamics, to name only a few.

Only recently, the growth of computational power gave autonomous decision making methods from the area of artificial intelligence a second wind, making available new methods and tools to tackle the challenges outlined before. One such example is Deep Learning, a powerful method that makes use of GPU hardware to build models with unseen capabilities to automatically construct relevant features from data.

During the analysis phase, the expert at the remote diagnostics center (RDC) normally enriches the sensor data available in the above mentioned step (1) with his findings and hypotheses about failure modes and solutions, all of which are documented in a ticketing system (e.g., Salesforce) as free text in natural language. While this unstructured or semi-structured way of documentation is convenient for the technician, it makes it very hard to share the knowledge expressed in these annotations with other colleagues. The information in these tickets is used to propose solutions based on similar cases from the past. The challenge is therefore to provide a system that may automatically propose relevant historic cases to the technician during diagnosis, where both sensor data as well as human-generated content (e.g., intermediary human-generated content), mostly textual information, is taken into account. It is not practically feasible to have a solution that needs extensive manual tuning of parameters to perform well. Up to now, the diagnostic process in the remote diagnostic center (RDC) is largely manual and lacks support through software tools.

Several methods and systems for generating first-level support recommendations for current critical situations are known from the prior art. The recommendations aim at resolving observed problems of technical systems or reducing future damages caused by the systems. Other recommendations may be directed to the optimization of resource consumption, the output of the system, and increase of lifetime by reducing wear.

According to prior art, for example, machine data and human-generated texts are jointly analyzed to create a unified representation of the current situation. Similar historic situations may be identified from a case base using this unified representation and presented to an engineer along with further solutions. Then, the engineer may pick relevant parts from the solutions and combine the relevant parts into one text. The resulting text is provided to the customer.

In other words, current approaches simply result in a list of similar known cases as possible solutions. The engineer has to manually find the best or most appropriate solution in this list. However, this approach is not applicable in various diagnostic scenarios. In many scenarios, specific cases may not be assigned to a similar known case. Accordingly, no solution or no appropriate solution may be found often. Especially in the scenario of first-level support, for example, users require one clear recommendation instead of a list of potentially relevant cases from which the users have to choose appropriate measures to take.

Diagnostic scenarios may require a complex dialogue with the engineer. For example, a first recommendation indicates that the engineer should check whether the measured values are in a pre-defined range. If the current values are not within the pre-defined range, the engineer will require at least one further recommendation. However, the dialogue may not be realized with common approaches.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a method for generating at least one recommendation, which is efficient and interactive, is provided.

In one embodiment, a method for generating at least one recommendation includes receiving a case embedding, generating the at least one recommendation based on the case embedding using deep learning, and outputting the at least one recommendation.

Accordingly, a case embedding is received as input in the first act. The case embedding may be defined as an embedded case study that is a case study containing more than one sub-unit of analysis, such as distinct data documenting the current state of investigations and findings concerning wind turbines or other units. The method is applicable to process distinct input data types, including machine data and human-generated data. The machine data is, for example, audio, image, or video data. The human-generated data is, for example, text data.

Then, the input is processed into one or more recommendations as output or result in a further act using deep learning. Distinct deep learning approaches or methods may be selected depending on the data type and application field. Thus, the method provides a high degree of flexibility.

The one or more recommendation is outputted. For example, the recommendation may be outputted to one or more users or further processed by a computing unit for applying the recommendation. In other words, the recommendation may be manually or automatically applied.

The recommendation may be used in various application fields, including diagnostic scenarios. In an exemplary diagnostic scenario, high vibrations in a bearing or other unit of, for example, a wind turbine is observed by a user, such as an expert for wind turbines performing maintenance works. After this observation, the user needs a recommendation to accurately or correctly handle the vibrations. Accordingly, the term “recommendation” may be considered as solution to a technical problem or task.

The method according to the present embodiments outputs the appropriate recommendation automatically to the user. The recommendation indicates an instruction for the user to check whether specific measurements are in range or not. If the measurements are out of range, the user may get further recommendations. This way, the gas turbine diagnostics may be optimized. The optimized diagnostics may be used to adjust the operation of rotation equipment and/or to maintain the rotation equipment. Alternatively, instead of manually applying the recommendations by a user, the recommendations may be automatically handled without user interaction. This way, the present embodiments allow the generation of the at least one recommendation in an efficient and user-friendly manner.

In one aspect, the case embedding is a unified representation (e.g., a unified numeric vector).

In a further aspect, the unified representation is a concatenation of a plurality of numeric vectors, including text feature vectors or vectors representing measured data.

In a further aspect, deep learning uses a case based reasoning learning method such as, for example, long short term memory (LSTM) recurrent neural network or deep convolutional generative adversarial networks (GAN).

Deep learning may use a case based reasoning learning method. For example, a natural language training method may be used for extracting semantic information. Different weights may be applied to different types of text features.

In a further aspect, the at least one recommendation is outputted as machine-readable or human-readable data. Accordingly, the recommendation may be processed or applied by machine or human, such as a computing unit or user. This way, the flexibility regarding the application field is provided.

In a further aspect, the method includes the further act of extending the case embedding with further information after the receiving of the case embedding for generating the at least one recommendation based on the extended case embedding using deep learning. Accordingly, the method allows for user interaction. Consequently, the case embedding may be updated with user content and may be improved in this manner.

In a further aspect, the at least one recommendation may be output to a user for applying the at least one recommendation (e.g., as a solution in a diagnostic scenario). Accordingly, the resulting recommendation is output to a user for being applied by the user. For example, the recommendation may be visually displayed to the user.

A further aspect is a corresponding generator unit.

A further aspect is a device including an embedder unit (e.g., an embedder) for providing a case embedding, and a generator unit (e.g., a generator) for performing the above mentioned method. The embedder and the generator may be formed by one or more processors.

A further aspect is a computer program (e.g., product) directly loadable into the internal memory (e.g., a non-transitory computer-readable storage medium) of a computer, including software code portions for performing the acts of the above-mentioned method when the computer program (product) is running on a computer or on one of the above mentioned apparatus.

### BRIEF DESCRIPTION OF THE DRAWINGS

FIG. 1 shows a schematic flow chart of a method for generating at least one recommendation in accordance with an embodiment;

FIG. 2 shows a schematic device in accordance with an embodiment; and

FIG. 3 shows the device including user interaction according to an embodiment.

### DETAILED DESCRIPTION

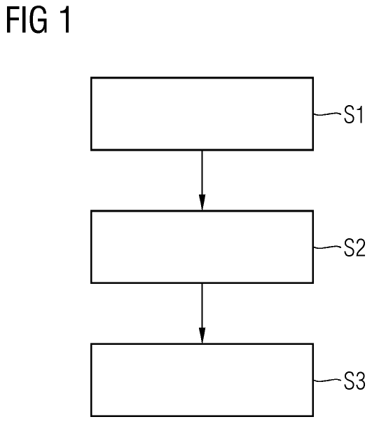

FIG. 1 illustrates a flow diagram of one embodiment of a method for generating at least one recommendation 40 according. First, in act S1, a case embedding 30 is received by a generator unit 20 (e.g., a generator). The case embedding 30 may be computed for a specific case or situation. Usually, the case embedding 30 is obtained based on deep learning.

Then, the one or more recommendations 40 are generated based on the case embedding 30 using a deep learning approach in act S2. Thereby, different deep learning approaches may be utilized, such as LSTM or GAN. For example, the LSTM is suitable, for example, for processing text data or audio data, similar to Google Translate or Deepjazz, respectively.

The recommendation 40 is outputted in act S3. The recommendation 40 may be outputted as textual description of a solution along with a schematic drawing detailing the text to a user. This way, the diagnostic engineer, as an exemplary user, is alleviated of the need to manually identify relevant parts of a result set with solutions being displayed. The diagnostic engineer, for example, is also alleviated of the need to combine the relevant parts into one semantically meaningful and consistent text as recommendation to, for example, the customer according to prior art. In other words, the engineer no longer has to compile the solution manually.

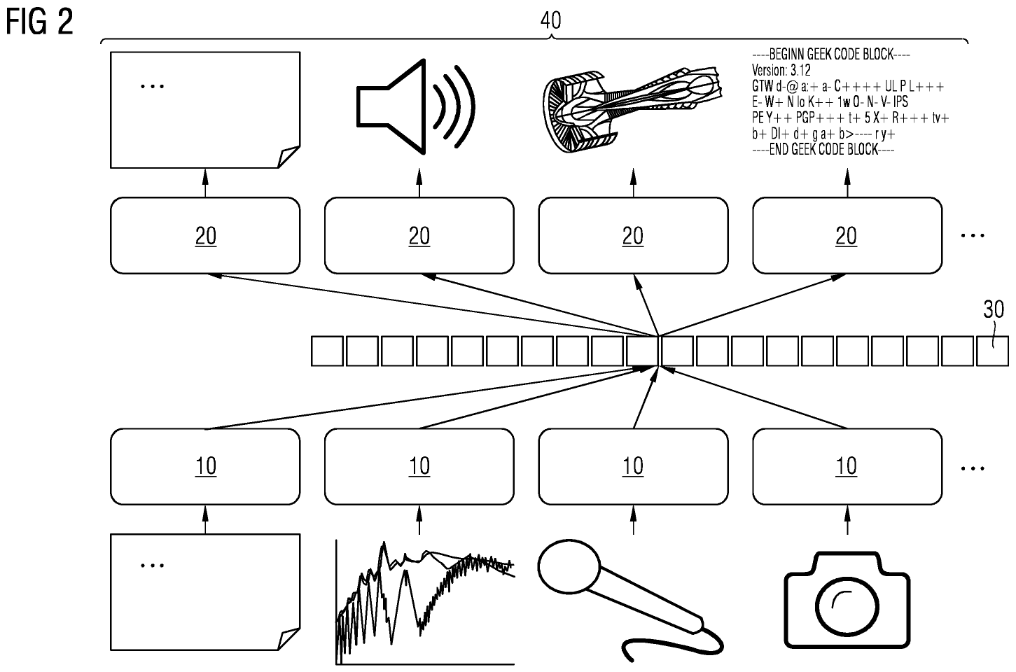

FIG. 2 shows an illustrative view of the device according to an embodiment. As illustrated, the device has a plurality of embedder units 10 and a plurality of respective generator units 20. Alternatively, the device may have solely one embedder and generator unit, more or less units, etc.

Each embedder unit 10 of the plurality of embedder units may process a specific data type, such as human-readable data or machine-readable data. The human-readable data may be text data, and the machine-readable data may be video or audio data, for example. Each data or content is represented as a numeric vector. Accordingly, for example, the text data is represented as one vector. The concatenation of the plurality of numeric vectors results in the case embedding as unified representation, which is used as input for a generator unit 20. The generator unit 20 processes the case embedding 30. Therefore, the generator unit 20 uses an approach or method depending on the type of content to be generated, as previously outlined. For example, LSTM may be selected for text data. It follows that each generator unit 20 of the plurality of generator units 20 may use a specific deep learning approach. Alternatively, the distinct approaches may be realized in one computing unit.

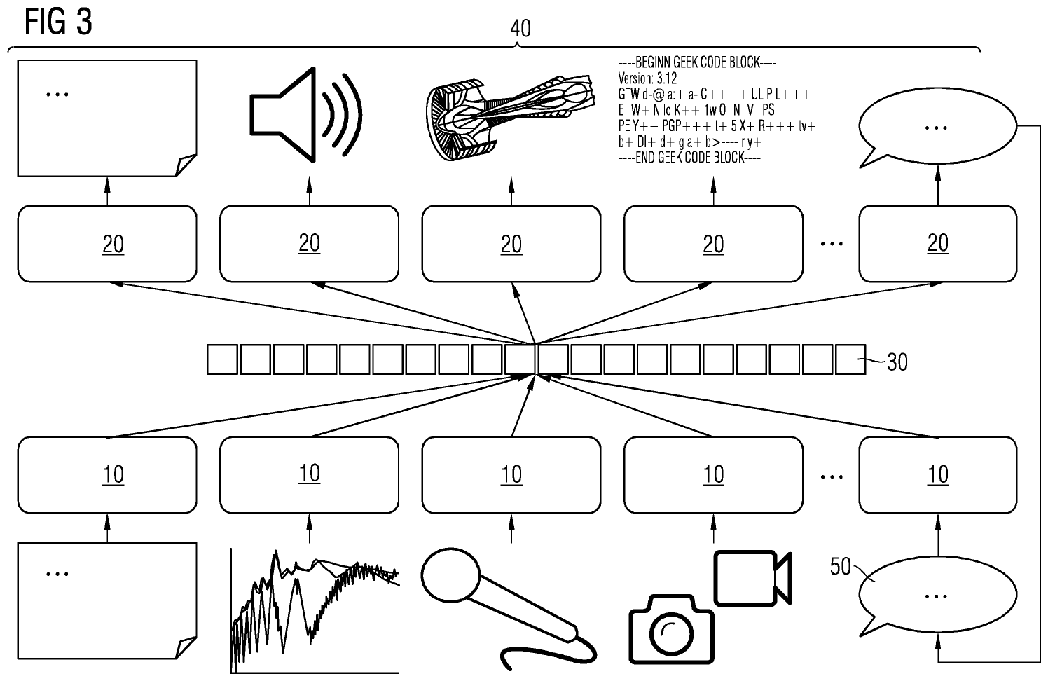

FIG. 3 shows a modification of the device with user interaction according to an embodiment. As illustrated, the user interacts with the device and, for example, extends the case embedding 30 with further information 50 or data content. Alternatively, each change of the case embedding is possible, including correction or deletion of information.

For example, a first recommendation 40 is outputted to the user, which indicates to check whether measurements are in range or out of range. After performing the indicated check, the user may respond to the device whether the measurements are in range or out of range.

Accordingly, the embedder unit 10 may receive the user feedback as, for example, text data after the first recommendation 40 is applied by the user or device. After receipt of the feedback, the case embedding 30 is updated based on the feedback or response of the user. The generator unit 20 generates one further recommendation using the extended case embedding 30. After the generation of the further recommendation, the user receives the further recommendation. The further information indicates to check specific values, for example.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for generating at least one recommendation, the method comprising:
receiving a case embedding;
generating the at least one recommendation based on the case embedding using deep learning; and
outputting the at least one recommendation.

2. The method of claim 1, wherein the case embedding is a unified representation.

3. The method of claim 2, wherein the unified representation is a concatenation of a plurality of numeric vectors including text feature vectors or vectors representing measured data.

4. The method of claim 1, wherein the deep learning uses a long short term memory (LSTM) recurrent neural network, a deep convolutional generative adversarial network (GAN), or the LSTM recurrent neural network and the deep convolutional GAN.

5. The method of claim 1, wherein the at least one recommendation is outputted as machine-readable or human-readable data.

6. The method of claim 1, further comprising extending the case embedding with further information after the receiving of the case embedding for generating the at least one recommendation based on the extended case embedding using deep learning.

7. The method of claim 1, wherein outputting the at least one recommendation comprises outputting the at least one recommendation to a user for applying the at least one recommendation as a solution in a diagnostic scenario.

8. A generator unit for generating at least one recommendation, the generator unit comprising:
a processor configured to:
receive a case embedding;
generate the at least one recommendation based on the case embedding using deep learning; and
output the at least one recommendation.

9. A device for generating at least one recommendation, the device comprising:
an embedder configured to provide a case embedding, and
a generator configured to generate the at least one recommendation, the generation of the at least one recommendation comprising:
receipt of the case embedding;
generation of the at least one recommendation based on the case embedding using deep learning; and
output of the at least one recommendation.

10. (canceled)

11. The method of claim 2, wherein the unified representation is a unified numeric vector.

12. In a non-transitory computer-readable storage medium that stores instructions executable by a computer to generate at least one recommendation, the instructions comprising:
receiving a case embedding;
generating the at least one recommendation based on the case embedding using deep learning; and
outputting the at least one recommendation.
